(19) United States
(12) Patent Application Publication
(10) Pub. No.: US 2006/0255579 A1
(43) Pub. Date: Nov. 16, 2006

(54) Vehicle occupant protection apparatus having foldable fill tube

(75) Inventors: John P. Wallner, Rochester Hills, MI (US); William P. Braun, Romeo, MI (US); Neal H. Delventhal, Lake Orion, MI (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Vehicle Safety Systems Inc.

(21) Appl. No.: 11/129,135

(22) Filed: May 13, 2005

(51) Int. Cl. B60R 21/26; B60R 21/213

(52) U.S. Cl. 280/740; 280/730.2; 280/742

(57) ABSTRACT

A vehicle occupant protection apparatus (10) includes an occupant protection device (14) and an inflation fluid source (12) that is actuatable for providing inflation fluid for inflating the occupant protection device (14). The apparatus (10) also includes a conduit (34) for directing a flow of inflation fluid from the inflation fluid source (12) to the occupant protection device (14). The conduit (34) includes two rigid portions (40 and 42) and a flexible portion (70) that is interposed between the rigid portions (40 and 42). The flexible portion (70) of the conduit (34) directs the flow of inflation fluid from one rigid portion (40) to the other rigid portion (42) and permits the rigid portions (40 and 42) to be moved relative to one another while remaining connected through the flexible portion (70).

### TECHNICAL FIELD

The present invention relates to an inflatable vehicle occupant protection apparatus. More particularly, the present invention relates to an inflatable vehicle occupant protection apparatus having a fill tube that may be folded.

### BACKGROUND OF THE INVENTION

It is known to inflate an inflatable vehicle occupant protection apparatus to help protect a vehicle occupant. One particular type of inflatable vehicle occupant protection apparatus includes an inflatable curtain. An inflatable curtain is inflatable away from the roof of the vehicle and into a position between a vehicle occupant and the side structure of the vehicle.

It is also known to use a fill tube to direct inflation fluid from an inflator to an inflatable curtain. A fill tube typically is an elongated conduit having one end connected to a fluid outlet of the inflator and an opposite end located in the inflatable curtain. The fill tube includes multiple exit ports that are spaced from one another along a length of the fill tube. Inflation fluid exiting the fill tube through the exit ports enters the inflatable curtain for inflating the inflatable curtain.

An inflatable vehicle occupant protection apparatus having an inflatable curtain typically is shipped to a vehicle manufacturer in an assembled condition. In the assembled condition, the fill tube extends from the inflator and into the inflatable curtain. The inflatable curtain is folded into a stored condition adjacent the fill tube. A covering is placed around the folded inflatable curtain to maintain the inflatable curtain in the stored condition adjacent the fill tube.

The assembled inflatable vehicle occupant protection apparatus generally is relatively long, for example, the full length of the vehicle occupant compartment. Often, a special shipping container is required for transporting the assembled inflatable vehicle occupant protection apparatus. Reducing the length of the assembled inflatable vehicle occupant protection apparatus for shipping may enable the use of a standard, less expensive shipping container.

Additionally, difficulties may arise in inserting an assembled inflatable vehicle occupant protection apparatus into the interior of a vehicle for installation. Reducing the length of the assembled inflatable vehicle occupant protection apparatus may make the inflatable vehicle occupant protection apparatus more maneuverable and may simplify insertion into the interior of a vehicle during installation.

### SUMMARY OF THE INVENTION

The present invention relates to a vehicle occupant protection apparatus comprising an occupant protection device that is inflatable for helping to protect an occupant of a vehicle. The vehicle occupant protection apparatus also comprises an inflation fluid source that is actuatable for providing inflation fluid for inflating the occupant protection device. A conduit directs a flow of inflation fluid from the inflation fluid source to the occupant protection device. The conduit includes two rigid portions and a flexible portion that is interposed between the rigid portions. The flexible portion of the conduit directs the flow of inflation fluid from one rigid conduit to the other rigid conduit and permits the two rigid portions to be moved relative to one another while remaining connected through the flexible portion.

According to another aspect, the present invention relates to a vehicle occupant protection apparatus comprising an occupant protection device that is inflatable for helping to protect an occupant of a vehicle. An inflation fluid source is actuatable for providing inflation fluid for inflating the occupant protection device. A conduit directs a flow of inflation fluid from the inflation fluid source to the occupant protection device. The conduit includes two rigid portions and a flexible portion that is interposed between the rigid portions. The flexible portion of the conduit directs the flow of inflation fluid from one rigid portion to the other rigid portion and permits the two rigid portions to be moved into generally parallel positions, without being coaxial with one another, while remaining connected through the flexible portion.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 illustrates a vehicle occupant protection apparatus constructed in accordance with the present invention;

FIG. 2 illustrates the vehicle occupant protection apparatus of FIG. 1 in a folded condition;

FIG. 3 illustrates a portion of a fill tube of the vehicle occupant protection apparatus of FIG. 1, in an unfolded condition;

FIG. 4 illustrates the portion of the fill tube of FIG. 3, in a folded condition;

FIG. 5 illustrates a portion of a first alternative fill tube for the vehicle occupant protection apparatus of FIG. 1, in an unfolded condition;

FIG. 6 illustrates the portion of the fill tube of FIG. 5, in a folded condition;

FIG. 7 is a view taken along line 7-7 in FIG. 5;

FIG. 8 illustrates a portion of a second alternative fill tube for the vehicle occupant protection apparatus of FIG. 1, in an unfolded condition;

FIG. 9 illustrates the portion of the fill tube of FIG. 8, in a folded condition; and

FIG. 10 is an enlarged view of a portion of a flexible portion of the fill tube of FIG. 8.

### DETAILED DESCRIPTION OF THE INVENTION

FIG. 1 illustrates a vehicle occupant protection apparatus 10 constructed in accordance with the present invention. The vehicle occupant protection apparatus 10 includes an inflator 12 and an inflatable occupant protection device 14.

The inflator 12 is actuatable for providing inflation fluid for use in inflating the inflatable occupant protection device 14. The inflator 12 may include a stored quantity of pressurized inflation fluid and an ignitable material for heating the inflation fluid. Alternatively, the inflator 12 may include a combustible gas generating material, a stored quantity of pressurized inflation fluid, or any other source for providing inflation fluid.

The inflatable occupant protection device 14 of FIG. 1 is an inflatable curtain. Alternatively, the inflatable occupant protection device 14 may be an inflatable frontal or side air bag, an inflatable seat belt, an inflatable knee bolster, an inflatable headliner, or a knee bolster operated by an inflatable air bag. The inflatable curtain 14 is preferably made from a flexible fabric material, such as woven nylon.

FIG. 1 illustrates the inflatable curtain 14 in a deflated and stored condition. In the deflated and stored condition, the inflatable curtain 14 is folded and stored within a housing 16. The inflatable curtain 14, in the deflated and stored condition, and the housing 16 have longitudinally elongated configurations.

The housing 16 is made from a flexible fabric material. Tear seams (not shown) are formed in the housing 16. The tear seams are designed to tear during inflation of the inflatable curtain 14 to enable the inflatable curtain to exit the housing 16. The housing 16 is mounted to a vehicle 18 in a location adjacent both the side structure of the vehicle and a roof 20 of the vehicle. The side structure of the vehicle 18 illustrated in FIG. 1 includes an A-pillar 22, a B-pillar 24, a C-pillar 26, and side windows 28 and 30. FIG. 1 shows four mounting brackets 32 for securing the housing 16 to the side structure of the vehicle 18.

The vehicle occupant protection apparatus 10 also includes a fill tube 34 that forms an inflation fluid conduit between the inflator 12 and the inflatable curtain 14. The fill tube 34 extends from an outlet of the inflator 12 and into the inflatable curtain 14. In the embodiment illustrated in FIG. 1, the fill tube 34 has a length that is approximately equal to the length of the inflatable curtain 14. Also, in the embodiment illustrated in FIG. 1, the fill tube 34 extends longitudinally through approximately ninety percent of the inflatable curtain 14.

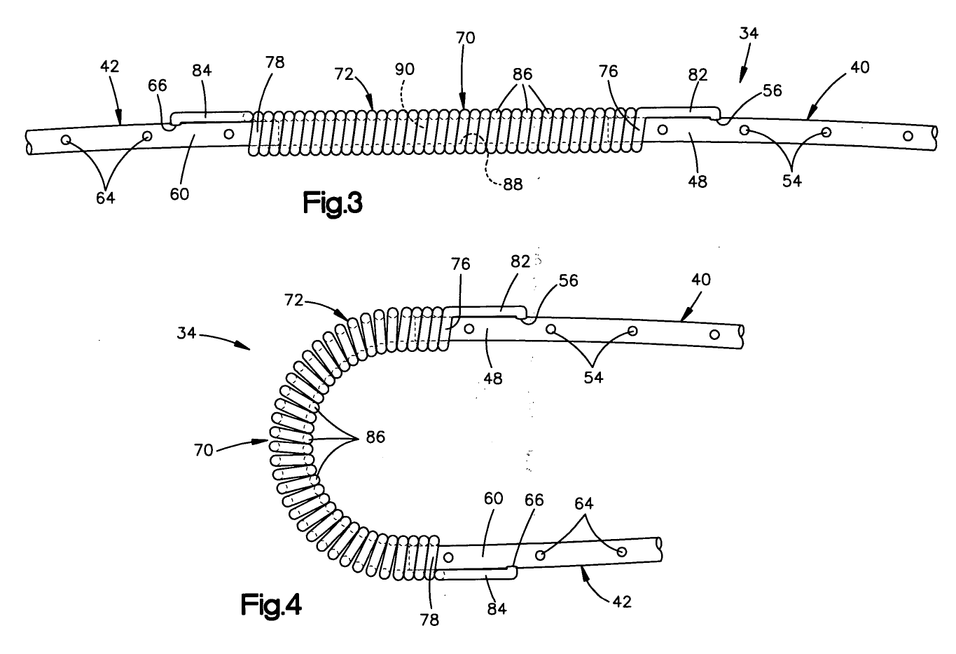

FIGS. 3 and 4 illustrate a portion of the fill tube 34 in unfolded and folded conditions, respectively. The fill tube 34 includes first and second rigid tubular portions 40 and 42, respectively. The first and second rigid tubular portions 40 and 42 of the fill tube 34 illustrated in FIG. 1 have approximately identical diameters. Each of the first and second rigid tubular portions 40 and 42 also includes a central passage (not shown) through which inflation fluid may flow. Preferably, the first and second rigid tubular portions 40 and 42 are formed from metal tubing. Alternatively, the first and second rigid tubular portions 40 and 42 may be formed from other materials, such as plastic.

As shown in FIG. 1, the first rigid tubular portion 40 includes opposite first and second ends 46 and 48, respectively. The first end 46 of the first rigid tubular portion 40 is attached to the outlet of the inflator 12 so that inflation fluid provided by the inflator is directed into the central passage of the first rigid tubular portion. Approximately twenty-five percent of the length of the first rigid tubular portion 40 is located outside of the inflatable curtain 14 and the housing 16. The remaining approximately seventy-five percent of the length of the first rigid tubular portion 40 extends into the inflatable curtain 14 and the housing 16.

The first rigid tubular portion 40 of the fill tube 34 includes multiple flow passages 54 (FIG. 3). The flow passages 54 are located in the portion of the first rigid tubular portion 40 that is located within the inflatable curtain 14. The flow passages 54 extend into the first rigid tubular portion and connect to the central passage. FIG. 3 illustrates the flow passages 54 spaced longitudinally from one another. Other arrangements of the flow passages 54 are also contemplated by the present invention. For example, the flow passages 54 may be arranged in groups with each group being spaced longitudinally from other groups. The flow passages 54 are adapted to direct inflation fluid from the central passage of the first rigid tubular portion 40 into the inflatable curtain 14.

The first rigid tubular portion 40 of the fill tube 34 also includes a through-hole 56 that extends into the first rigid tubular portion and terminates at the central passage. The through-hole 56 is located adjacent the second end 48 of the first rigid tubular portion 40. In FIG. 3, the through-hole 56 is spaced away from the flow passages 54 about the circumference of the first rigid tubular portion 40 of the fill tube 34 by approximately ninety degrees.

As shown in FIG. 1, the second rigid tubular portion 42 also includes opposite first and second ends 60 and 62, respectively. The second rigid tubular portion 42, in its entirety, is located within the inflatable curtain 14 of the vehicle occupant protection apparatus 10.

Multiple flow passages 64 (FIG. 3) extend into the second rigid tubular portion 42 and connect to the central passage within the second rigid tubular portion. FIG. 3 illustrates the flow passages 64 spaced longitudinally from one another. Other arrangements of the flow passages 64 are also contemplated by the present invention. For example, the flow passages 64 may be arranged in groups with each group being spaced longitudinally from other groups. The flow passages 64 are spaced along the entire length of the second rigid tubular portion 42. The flow passages 64 are adapted to direct inflation fluid from the central passage of the second rigid tubular portion 42 into the inflatable curtain 14.

The second rigid tubular portion 42 of the fill tube 34 also includes a through-hole 66 that extends into the second rigid tubular portion and terminates at the central passage. The through-hole 66 is located adjacent the first end 60 of the second rigid tubular portion 42. In FIG. 3, the through-hole 66 is spaced away from the flow passages 64 about the circumference of the second rigid tubular portion 42 of the fill tube 34 by approximately ninety degrees.

The fill tube 34 also includes a flexible portion 70. The flexible portion 70 of the fill tube 34 is formed from a coil spring 72 (FIG. 3). The flexible portion 70 includes opposite first and second ends 76 and 78, respectively. A first hook 82 extends from the first end 76 of the flexible portion 70 and a second hook 84 extends from the second end 78 of the flexible portion. Multiple coils 86 extend between the first and second ends 76 and 78 of the flexible portion 70. Each coil 86 of the coil spring 72 has an inner diameter, indicated generally at 88 in FIG. 3, that is approximately equal to the outer diameters of the first and second rigid tubular portions 40 and 42.

The coil spring 72 is biased into the relatively straight condition illustrated in FIG. 3. When in the condition illustrated in FIG. 3, adjacent coils 86 of the coil spring 72 abut one another so that a central passage 90 is formed through the coil spring. The inner diameters 88 of the coils 86 collectively define the central passage 90. The coils 86 of the coil spring 72 may be coated with a material, such as rubber, for preventing gas leaks between adjacent coils 86 when the coil spring 72 is in the condition illustrated in FIG. 3. Alternatively, the fill tube 34 may extend through a sleeve portion (not shown) of the inflatable curtain 14 that fits snugly around the flexible portion 70 of the fill tube 34 for preventing gas leaks between adjacent coils of the coil spring 72.

When the fill tube 34 of the vehicle occupant protection apparatus 10 is assembled, the flexible portion 70 of the fill tube 34 is interposed between the first and second rigid tubular portions 40 and 42. To connect the flexible portion 70 between the first and second rigid tubular portions 40 and 42, the second end 48 of the first rigid tubular portion 40 is inserted into the central passage 90 of the flexible portion 70 from the first end 76. The first hook 82 is aligned with and inserted into the through-hole 56 of the first rigid tubular portion 40 to secure the flexible portion 70 to the first rigid tubular portion. Similarly, the first end 60 of the second rigid tubular portion 42 is aligned with and inserted into the central passage 90 of the flexible portion 70 from the second end 78. The second hook 84 is inserted into the through-hole 66 of the second rigid tubular portion 42 to secure the flexible portion 70 to the second rigid tubular portion.

In the assembled fill tube 34, the central passage 90 of the flexible portion 70 interconnects the central passages of the first and second rigid tubular portions 40 and 42. Also in the assembled fill tube 34, there is no reduction of inflation fluid flow through the flexible portion 70 of the fill tube 34 since the flow area of the central passage 90 of the flexible portion is equal to or greater than the flow areas of the central passages through the first and second rigid tubular portions 40 and 42 of the fill tube.

The assembled fill tube 34 may be folded. FIG. 3 illustrates a portion of the fill tube 34 in an unfolded condition. FIG. 4 illustrates the portion of the fill tube 34 in a folded condition. The flexible portion 70 of the fill tube 34 enables the fill tube to be folded. When the fill tube 34 is folded into the condition illustrated in FIG. 4, the second end 78 of the flexible portion 70 is moved from a position longitudinally spaced relative to the first end 76 of the flexible portion, as is shown in FIG. 3, to a position longitudinally aligned with the first end of the flexible portion. In the condition illustrated in FIG. 4, adjacent coils 86 of the coil spring 72 that forms the flexible portion 70 of the fill tube 34 remain in abutting contact along an inner diameter of the bend in the flexible portion, while adjacent coils are spaced away from one another along an outer diameter of the bend.

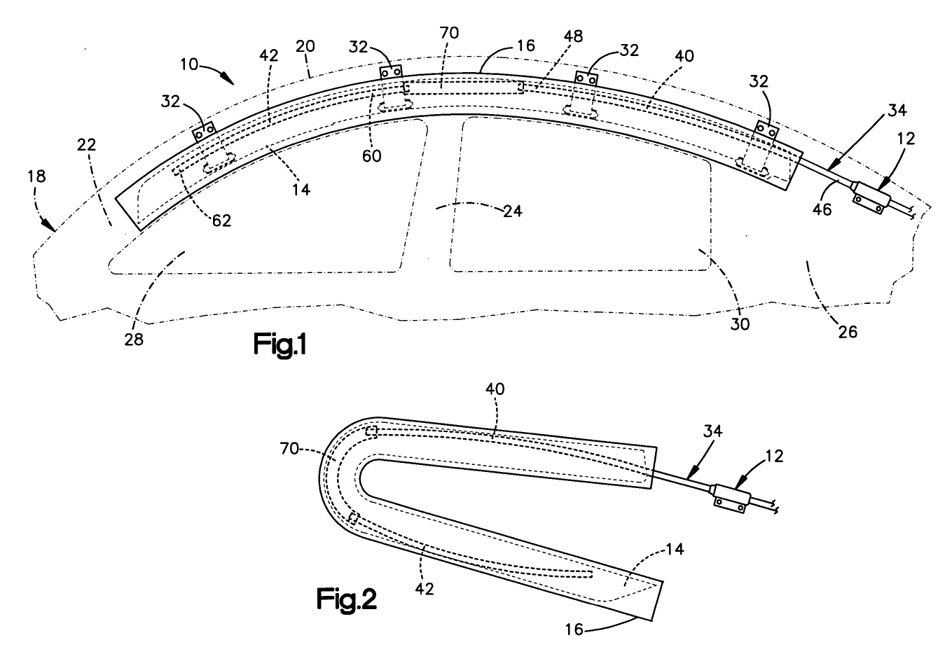

Because the fill tube 34 can be folded the assembled vehicle occupant protection apparatus 10 can also be folded. FIG. 2 illustrates the assembled vehicle occupant protection apparatus 10 in a folded condition. When the vehicle occupant protection apparatus 10 is in the folded condition, the inflatable curtain 14 and the housing 16 fold with the flexible portion 70 of the fill tube 34.

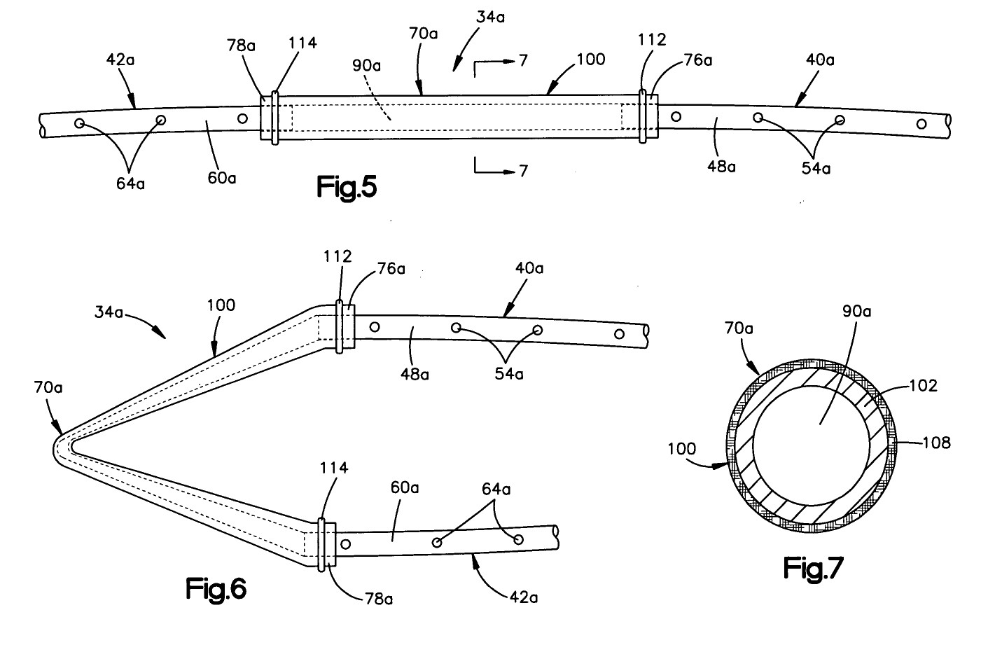

FIGS. 5 and 6 illustrate a portion of a first alternative fill tube 34a for the vehicle occupant protection apparatus 10 of FIG. 1. Features of the fill tube 34a of FIGS. 5 and 6 that are the same as or similar to those of FIGS. 3 and 4 are labeled using the same reference numbers with the addition of the suffix “a”.

FIG. 5 illustrates the fill tube 34a in an unfolded condition. FIG. 6 illustrates the fill tube in a folded condition. The fill tube 34a includes first and second rigid tubular portions 40a and 42a, respectively. The first and second rigid tubular portions 40a and 42a of the fill tube 34a have approximately identical outer diameters. Each of the first and second rigid tubular portions 40a and 42a also includes a central passage (not shown) through which inflation fluid may flow. Preferably, the first and second rigid tubular portions 40a and 42a are formed from metal tubing. Alternatively, the first and second rigid tubular portions 40a and 42a may be formed from other materials, such as plastic.

The first rigid tubular portion 40a includes opposite first and second ends. Only the second end 48a of the first rigid tubular portion 40a is illustrated in FIGS. 5 and 6. The first end of the first rigid tubular portion 40a is attachable to the inflator 12 of the vehicle occupant protection apparatus 10 so that inflation fluid provided by the inflator may be directed into the central passage of the first rigid tubular portion.

The first rigid tubular portion 40a of the fill tube 34a includes multiple flow passages 54a that extend into the first rigid tubular portion and connect to the central passage. The flow passages 54a are located in a portion of the first rigid tubular portion 40a of the fill tube 34a that is located within the inflatable curtain 14 of the assembled vehicle occupant protection device 10. FIG. 5 illustrates the flow passages 54a spaced longitudinally from one another. Other arrangements of the flow passages are also contemplated by the present invention. The flow passages 54a are adapted to direct inflation fluid from the central passage of the first rigid tubular portion 40a into the inflatable curtain 14.

The second rigid tubular portion 42a also includes opposite first and second ends. Only the first end 60a of the second rigid tubular portion 42a is illustrated in FIGS. 5 and 6. The second rigid tubular portion 42a is adapted to be received, in its entirety, within the inflatable curtain 14 of the assembled vehicle occupant protection apparatus 10.

Multiple flow passages 64a extend into the second rigid tubular portion 42a and connect to the central passage within the second rigid tubular portion. FIG. 5 illustrates the flow passages 64a spaced longitudinally from one another. Other arrangements of the flow passages 64a are also contemplated by the present invention. The flow passages 64a are spaced along the entire length of the second rigid tubular portion 42a. The flow passages 64a are adapted to direct inflation fluid from the central passage of the second rigid tubular portion 42a into the inflatable curtain 14.

The fill tube 34a also includes a flexible portion 70a. The flexible portion 70a is formed from a hose 100. Preferably, the hose 100 is of the type commonly referred to as a “run-flat hose.” FIG. 7 illustrates a sectional view of a preferred embodiment of the hose 100. The hose 100 includes a tubular rubber liner 102 that defines a central passage 90a of the flexible portion 70a. A braided cloth covering 108 surrounds the tubular rubber liner 102 and acts to reinforce the tubular rubber liner.

The flexible portion 70a of the fill tube 34a includes opposite first and second ends 76a and 78a, respectively. A first clamp 112 is associated with the first end 76a of the flexible portion 70a. A second clamp 114 is associated with the second end 78a of the flexible portion 70a.

When the fill tube 34a is assembled, the flexible portion 70a of the fill tube 34 is interposed between the first and second rigid tubular portions 40a and 42a. To connect the flexible portion 70a between the first and second rigid tubular portions 40a and 42a, the second end 48a of the first rigid tubular portion 40 is inserted into the central passage 90a of the flexible portion 70a from the first end 76a. The first clamp 112 is positioned over the first end 76a of the flexible portion 70a to secure the flexible portion to the second end 48a of the first rigid tubular portion 40a. Similarly, the first end 60a of the second rigid tubular portion 42a is inserted into the central passage 90a of the flexible portion 70a from the second end 78a. The second clamp 114 is positioned over the second end 78a of the flexible portion 70a to secure the flexible portion to the first end 60a of the second rigid tubular portion 42a.

In the assembled fill tube 34a, the central passage 90a of the flexible portion 70a interconnects the central passages of the first and second rigid tubular portions 40a and 42a. Also, in the assembled fill tube 34a, there is no reduction of inflation fluid flow through the flexible portion 70a of the fill tube 34a since the flow area of the central passage 90a through the flexible portion 70a is equal to or greater than the flow areas of the central passages through the first and second rigid tubular portions 40a and 42a.

The assembled fill tube 34a may be folded. FIG. 5 illustrates a portion of the fill tube 34a in an unfolded condition. FIG. 6 illustrates the portion of the fill tube 34a in a folded condition. When in the folded condition, the flexible portion 70a of the fill tube 34a flattens at the location of the fold, as shown in FIG. 6. The ability of the fill tube 34a to be folded enables an assembled vehicle occupant protection apparatus 10 that includes the fill tube 34a to be folded.

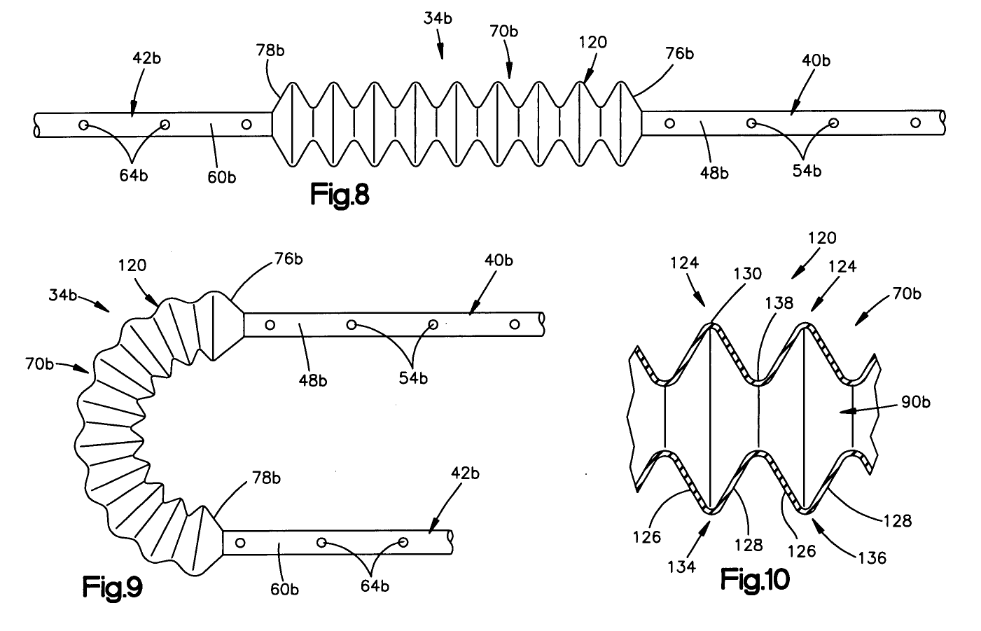

FIGS. 8 and 9 illustrate a portion of a second alternative fill tube 34b for the vehicle safety apparatus 10 of FIG. 1. Features of the fill tube 34b of FIGS. 8 and 9 that are the same as or similar to those of FIGS. 3 and 4 are labeled using the same reference numbers with the addition of the suffix “b”.

FIG. 8 illustrates the fill tube 34b in an unfolded condition and FIG. 9 illustrates the fill tube in a folded condition. The fill tube 34b includes first and second rigid tubular portions 40b and 42b, respectively. The first and second rigid tubular portions 40b and 42b of the fill tube 34b have approximately identical outer diameters. Each of the first and second rigid tubular portions 40b and 42b also includes a central passage (not shown) through which inflation fluid may flow. Preferably, the first and second rigid tubular portions 40b and 42b are formed from metal tubing. Alternatively, the first and second rigid tubular portions 40b and 42b may be formed from other materials, such as plastic.

The first rigid tubular portion 40b includes opposite first and second ends. Only the second end 48b of the first rigid tubular portion 40b is illustrated in FIGS. 8 and 9. The first end of the first rigid tubular portion 40b is attachable to the inflator 12 of the vehicle occupant protection apparatus 10 so that inflation fluid provided by the inflator may be directed into the central passage of the first rigid tubular portion.

The first rigid tubular portion 40b of the fill tube 34b includes multiple flow passages 54b that extend into the first rigid tubular portion and connect to the central passage. The flow passages 54b are located on a portion of the first rigid tubular portion 40b that is received in the inflatable curtain 14 of the assembled vehicle occupant protection apparatus 10. FIG. 8 illustrates the flow passages 54b spaced longitudinally from one another. Other arrangements of the flow passages are also contemplated by the present invention. The flow passages 54b are adapted to direct inflation fluid from the central passage of the first rigid tubular portion 40b into the inflatable curtain 14 (FIG. 1).

The second rigid tubular portion 42b also includes opposite first and second ends. Only the first end 60b of the second rigid tubular portion 42b is illustrated in FIGS. 8 and 9. The second rigid tubular portion 42b is adapted to be received, in its entirety, within the inflatable curtain 14 of the assembled vehicle occupant protection apparatus 10.

Multiple flow passages 64b extend into the second rigid tubular portion 42b and connect to the central passage within the second rigid tubular portion. FIG. 8 illustrates the flow passages 64b spaced longitudinally from one another. Other arrangements of the flow passages 64b are also contemplated by the present invention. The flow passages 64b are spaced along the entire length of the second rigid tubular portion 42b. The flow passages 64b are adapted to direct inflation fluid from the central passage of the second rigid tubular portion 42b into the inflatable curtain 14.

The fill tube 34b also includes a flexible portion 70b. The flexible portion 70b of the fill tube 34b is a flexible bellows 120 that is formed as one piece with the first and second rigid tubular portions 40b and 42b of the fill tube and not from separate pieces secured together. The flexible bellows 120 may be formed using any known bellows forming process. U.S. Pat. No. 3,937,051 discloses an example of a process that may be used for forming the flexible bellows 120. A central passage 90b (FIG. 10) extends through the flexible bellows 120.

The flexible bellows 120 includes multiple pleats 124. FIG. 10 is an enlarged view of a portion of the flexible bellows 120. As shown with reference to FIG. 10, each pleat 124 of the flexible bellows includes first and second portions 126 and 128, respectively. The first and second portions 126 and 128 of the pleat 124 mate with one another at a circumferential outer annular joint 130. The circumferential outer annular joint 130 forms the largest diameter portion of the pleat 124. Also, as shown in FIG. 10, the second portion 128 of a first pleat 134 mates with a first portion 126 of a second pleat 136 to form a circumferential inner annular joint 138. The circumferential inner annular joint 138 forms the smallest diameter portion of the pleat 124 and define a flow area of the central passage 90b of the flexible portion 70b of the fill tube 34b. When the fill tube 34b is in an unfolded condition, as shown in FIG. 8, the diameter of each inner annular joint 138 of the flexible bellows 120 is approximately equal to the diameter of the central passages through the first and second rigid tubular portions 40a and 42a.

The flexible portion 70b of the fill tube 34b includes opposite first and second ends 76b and 78b, respectively. The first end 76b of the flexible portion 70b mates with the second end 48b of the first rigid tubular portion 40b. The second end 78b of the flexible portion 70b mates with the first end 60b of the second rigid tubular portion 42b.

The central passage 90b of the flexible portion 70b of the fill tube 34b interconnects the central passages of the first and second rigid tubular portions 40b and 42b. There is no reduction of inflation fluid flow through the flexible portion 70b of the fill tube 34b relative to the flow through the first and second rigid tubular portions 40b and 42b since the flow area of the central passage 90b through the flexible portion is equal to or greater than the flow areas of the central passages through the first and second rigid tubular portions.

The fill tube 34b may be folded. FIG. 8 illustrates a portion of the fill tube 34b in an unfolded condition. FIG. 9 illustrates the portion of the fill tube 34b in a folded condition. The flexible portion 70b of the fill tube 34b enables the fill tube to be folded. When the fill tube 34b is folded, as is shown in FIG. 9, portions of the pleats 124 of the flexible portion 70b located on an inner diameter of the bend in the flexible portion are compressed toward one another and portions of the pleats on an outer diameter of the bend are expanded away from one another. Because the fill tube 34b can be folded, an assembled vehicle occupant protection apparatus that includes the fill tube 34b can also be folded.

From the above description of the invention, those skilled in the art will perceive improvements, changes and modifications. For example, each of the fill tubes may include multiple, spaced apart, flexible portions to enable multiple folds of the fill tube. Such improvements, changes and modifications within the skill of the art are intended to be covered by the appended claims.

Having described the invention, we claim the following:

1. A vehicle occupant protection apparatus comprising:
an occupant protection device that is inflatable for helping to protect an occupant of a vehicle;
an inflation fluid source that is actuatable for providing inflation fluid for inflating the occupant protection device; and
a conduit for directing a flow of inflation fluid from the inflation fluid source to the occupant protection device, the conduit including two rigid portions and a flexible portion that is interposed between the rigid portions, the flexible portion of the conduit directing the flow of inflation fluid from one rigid portion to the other rigid portion and permitting the two rigid portions to be moved relative to one another while remaining connected through the flexible portion.

2. The vehicle occupant protection apparatus of claim 1 wherein the rigid portions of the conduit are free of fluid directing couplings that extend through the flexible portion for connecting the rigid portions of the conduit.

3. The vehicle occupant protection apparatus of claim 1 wherein the conduit extends into the occupant protection device, the occupant protection device, when in a stored condition, being movable with the rigid portions of the conduit.

4. The vehicle occupant protection apparatus of claim 3 further including a housing, the occupant protection device, when in a stored condition, being located within the housing, the housing being movable with the rigid portions of the conduit.

5. The vehicle occupant protection apparatus of claim 1 wherein the flexible portion of the conduit is formed from a coil spring, a central passage of the coil spring providing a flow area of the flexible portion of the conduit.

6. The vehicle occupant protection apparatus of claim 5 wherein adjacent coils of the coil spring abut one another to define the central passage.

7. The vehicle occupant protection apparatus of claim 6 wherein the coil spring includes first and second hooks, the first hook being received in a through-hole of the first rigid portion for attaching the coil spring to the first rigid portion of the conduit, the second hook being received in a through-hole of the second rigid portion for attaching the coil spring to the second rigid portion of the conduit.

8. The vehicle occupant protection apparatus of claim 1 wherein the flexible portion of the conduit is a flexible hose, a central passage of the hose providing a flow area of the flexible portion of the conduit.

9. The vehicle occupant protection apparatus of claim 8 wherein the flexible hose includes a tubular rubber liner that defines the central passage.

10. The vehicle occupant protection apparatus of claim 9 wherein the flexible hose further includes a braided cloth covering that surrounds the tubular rubber liner.

11. The vehicle occupant protection apparatus of claim 8 further including first and second clamps, the first clamp securing the flexible hose to the first rigid portion of the conduit, the second clamp securing the flexible hose to the second rigid portion of the conduit.

12. The vehicle occupant protection apparatus of claim 1 wherein the flexible portion of the conduit is formed as one piece with the first and second rigid portions and not from separate pieces secured together.

13. The vehicle occupant protection apparatus of claim 12 wherein the flexible portion of the conduit is a flexible bellows, a central passage of the flexible bellows providing a flow area of the flexible portion of the conduit.

14. The vehicle occupant protection apparatus of claim 13 wherein the flexible bellows is formed from multiple pleats, each pleat including first and second portions, the first and second portions of each pleat mating at a circumferential outer annular joint.

15. The vehicle occupant protection apparatus of claim 14 wherein the second portion of a first pleat mates with the first portion of a second pleat at a circumferential inner annular joint, the circumferential inner annular joint forming a smallest diameter portion of the flexible portion of the conduit.

16. The vehicle occupant protection apparatus of claim 1 wherein the flexible portion of the conduit has a flow area for inflation fluid that is equal to or greater than a flow area through the rigid portions of the conduit.

17. A vehicle occupant protection apparatus comprising:
an occupant protection device that is inflatable for helping to protect an occupant of a vehicle;
an inflation fluid source that is actuatable for providing inflation fluid for inflating the occupant protection device; and
a conduit for directing a flow of inflation fluid from the inflation fluid source to the occupant protection device, the conduit including two rigid portions and a flexible portion that is interposed between the rigid portions, the flexible portion of the conduit directing the flow of inflation fluid from one rigid portion to the other rigid portion and permitting the two rigid portions to be moved into generally parallel positions, without being coaxial with one another, while remaining connected through the flexible portion.

18. The vehicle occupant protection apparatus of claim 17 wherein the flexible portion of the conduit is formed from a coil spring, a central passage of the coil spring providing a flow area of the flexible portion of the conduit.

19. The vehicle occupant protection apparatus of claim 17 wherein the flexible portion of the conduit is a flexible hose, a central passage of the hose providing a flow area of the flexible portion of the conduit.

20. The vehicle occupant protection apparatus of claim 17 wherein the flexible portion of the conduit is a flexible bellows, a central passage of the flexible bellows providing a flow area of the flexible portion of the conduit.
